(19) United States
(12) Patent Application Publication
(10) Pub. No.: US 2025/0279235 A1
(43) Pub. Date: Sep. 4, 2025

(54) MULTI-CHAMBER TRANSFORMER AND MOUNTING ASSEMBLY

(71) Applicant: Inventronics GmbH, Garching (DE)

(72) Inventor: Daniele LUCCATO, Treviso (IT)

(21) Appl. No.: 18/858,756

(22) PCT Filed: Apr. 11, 2023
(86) PCT No.: PCT/IB2023/053665

§ 371 Date: Oct. 22, 2024

(30) Foreign Application Priority Data
Apr. 29, 2022 (IT) 102022000008627

(51) Int. Cl. H01F 27/30; H01F 27/32; H01F 27/38

(52) U.S. Cl. CPC H01F 27/306; H01F 27/325; H01F 27/38

(57) ABSTRACT

A multi-chamber transformer includes windings wound on a coil former, which is provided with transverse flanges that define mutually insulated winding chambers arranged alongside one another in a longitudinal direction of the coil former between two outermost transverse flanges. A transformer core surrounds the windings wound on the coil former, with a first outer surface and a second outer surface that extend on opposite sides with respect to the windings. The coil former includes lateral extensions at the opposite ends of the first outer surface of the core, which carry electrically conductive pins having proximal ends coupled to the windings and distal ends projecting from the lateral extensions of the coil former.

### RELATED APPLICATIONS

This patent application is a US National Stage application, filed under 35 U.S.C. § 371, of International Application PCT/IB2023/053665, filed on Apr. 11, 2023, and claims priority under from Italian Patent Application No. 102022000008627, filed Apr. 29, 2022, the contents of the above applications are hereby incorporated by reference.

### TECHNICAL FIELD

The present disclosure relates to transformers, for example, in the sector of lighting technology.

### TECHNOLOGICAL BACKGROUND

An important sector of use for switching-type power-supplies is represented by power supply of solid-state lighting (SSL) sources, for example LED sources.

In such a context of application it is known to resort to multi-chamber transformers, as described, for example, in documents such as EP 1 693 860 B1 or EP 1 796 112 B1.

For applications of this nature (frequently designed for outdoor use), in addition to a contained cost, qualities of flexibility, compactness, efficiency, good dissipation of heat, and capacity to withstand overloads are appreciated.

Notwithstanding the extensive activity of innovation and research in the sector, there is still felt the need to have available solutions improved as regards aspects such as compactness (e.g., reduction of the overall dimensions of the transformer, in particular when it is set on a mounting support or substrate such as a printed circuit board—PCB), operating efficiency (good heat dissipation and capacity to withstand voltage overloads), and reduction in costs (possibility of managing without certain components, such as covers).

For instance, various solutions as described in documents such as US 2013/002386 A1, EP 2 402 964 A2, US 2012/038448 A1, US 2015/097646 A1, U.S. Pat. No. 6,727,793 B2, or US 2013/076473 A1 envisage resorting to annular transformer structures that are to be mounted on a substrate, such as a PCB, mounted, so to speak, flat, i.e., with the windings wound around an axis orthogonal to the plane of the substrate.

These solutions have overall dimensions that are likely to increase markedly as the number of windings increases. Moreover, these solutions may prove problematical to implement in an automated way both at the level of production of the windings (for example, in the case of solutions as described in EP 2 402 964 A2 or in US 2015/097646 A1, where the windings are arranged concentric with respect to one another and not alongside one another in a longitudinal direction with respect to the coil former) and as regards the electrical connection of the windings to the respective pins: in various cases, the space available for this purpose (for example, the stand-off distance from the substrate S) is in fact very small and/or is located in positions that are difficult to reach.

### SUMMARY

One or more embodiments regard a corresponding mounting assembly, comprising a transformer mounted on a substrate such as a PCB.

One or more embodiments may regard the shape of the coil former so as to render the core slimmer, thus containing and/or reducing the overall dimensions of the transformer set on a mounting substrate (for example, a PCB).

Other aspects touched upon are linked to the wide area a of the core within the coil former, to the positioning of the pins and/or to the reduction of the overall height of the transformer (thanks to a flexible stand-off) with the possibility of maintaining conditions of low losses.

For instance:
the transformer may in effect be laid on the substrate or support (for example, a PCB), keeping the top part of the core free so as to facilitate cooling;
there exists the possible possibility of inserting part of the core into the mounting substrate or support so as to reduce the overall dimensions of the transformer and keep both the top part and the bottom part of the core free in order to facilitate cooling thereof.

It is likewise possible to adjust the so-called stand-off so as to be able to achieve an adequate level of insulation of the pins with respect to the core.

The location of the pins at the corners makes it possible to obtain an adequate level of insulation between the ends of the windings. Recourse to a structure that enables a large magnetic area, reducing the number of turns leads to reduced leaks and makes it possible to reduce the level of electromagnetic interference (EMI), at the same time increasing the efficiency.

In brief, the examples presented herein enable reduction of the overall dimensions of the transformer, maintaining an adequate level of insulation from one side of the transformer to the other, likewise achieving advantages at the level of cooling and reduction of the height of the driver associated to the transformer.

### BRIEF DESCRIPTION OF THE DRAWINGS

One or more embodiments will now be described, purely by way of non-limiting example, with reference to the annexed drawings, wherein:

FIG. 1 is a circuit diagram of a power-supply device (converter) in which a transformer as described herein can find use;

FIG. 2 is a general perspective view of transformer as described herein, with some parts not visible in order not to overburden the representation;

FIG. 3 is a side elevation of a transformer as described herein, in which some parts are not visible so as to highlight characteristics of other parts of the transformer;

FIG. 4 reproposes part of FIG. 3 with still other parts removed for clarity of illustration;

FIG. 5 is a side elevation of the transformer described herein according to a point of view rotated through 90° with respect to FIG. 3;

FIG. 6 is a view of the portion of FIG. 2 indicated by the arrow VI reproduced at an enlarged scale;

FIG. 7 exemplifies the possibility of using the solution described herein for the purpose of providing transformers of different dimensions (and electrical characteristics);

FIG. 8 is a partially exploded perspective view with parts removed aimed at highlighting possible characteristics of embodiments;

FIG. 9 exemplifies possible modalities of mounting of a transformer as described herein on a substrate such as a PCB; and

FIG. 10 exemplifies possible modalities of mounting of a transformer as described herein on a substrate located within a housing.

It will be appreciated that, for simplicity and clarity of illustration, the views of the various FIGS. may not be in scale with respect to one another.

Moreover, except where the context indicates otherwise, parts or elements that are similar are designated in the various figures by the same references. Consequently, for brevity and simplicity of illustration, a detailed description of such parts or elements will not be repeated for each figure. Once again for brevity and simplicity of illustration, in the present description one and the same notation may possibly be used to indicate both a given node or line and a signal present on that node or line.

### DETAILED DESCRIPTION

In the ensuing description various specific details are illustrated in order to enable an in-depth understanding of various examples of embodiments according to the description. The embodiments may be obtained without one or more of the specific details, or with other methods, components, materials, etc. In other cases, known structures, materials, or operations are not illustrated or described in detail so that the salient aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Phrases such as “in an embodiment” or “in one embodiment” that may be present in various points of the present description do not necessarily refer exactly to the same embodiment. Moreover, particular conformations, structures, or characteristics may be combined in any adequate way in one or more embodiments.

The references used herein are provided merely for convenience and hence do not define the sphere of protection or the scope of the embodiments.

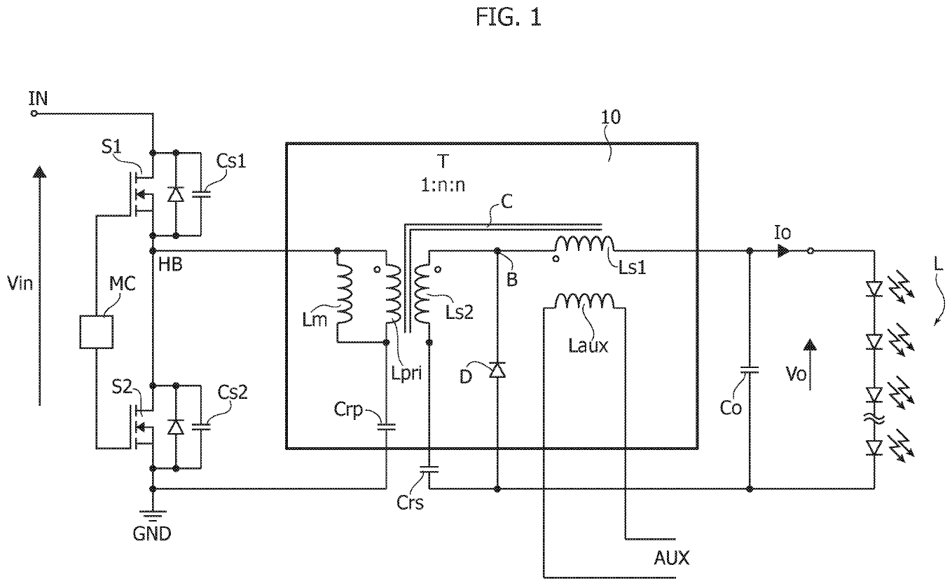

The electrical diagram of FIG. 1 exemplifies a power-supply circuit (converter) in which a transformer 10 as illustrated herein may find use.

Reference to the circuit diagram of FIG. 1 is merely provided by way of example: a transformer 10 as described herein may in fact be used also in the context of circuits altogether different from the one exemplified in FIG. 1.

In the example presented in FIG. 1, the transformer 10 is part of a power-supply device that is to convert an input voltage Vᵢₙ (applied to an input node IN on the left in FIG. 1) into an output voltage Vₒ present across an output capacitor Cₒ that is to be supplied to a load

L.

In the example presented herein (which, it is emphasized, is merely an example) the load L is constituted by a LED string across which the voltage Vₒ is applied, with the load L that receives a power-supply current Iₒ.

The reference Lpri denotes as a whole the primary winding of the transformer 10, that is to be coupled to a node HB in a stage of a switching type comprising a first switch S1 and a second switch S2 having the current paths through the switches cascaded between the input node IN and a reference node (such as a ground GND).

The first switch S1 is hence set between the node IN and the node HB, whereas the second switch S2 is set between the node HB and the reference node (for example, a ground GND). The switches S1 and S2 may be provided, for example, in the form of electronic switches, such as MOSFETs, which are able to define, with their source-to-drain conduction paths or channels, the current paths of the switches cascaded between the node IN and the reference level GND.

The switches S1 and S2 may alternatively be rendered conductive (ON) and non-conductive (OFF) as a function of signals applied to their control terminals (gate terminals, in the case of an implementation via field-effect transistors, such as MOSFETs) by a control device MC.

The switches S1 and S2 may be obtained as electronic switches, for example via MOSFETs: the representation of FIG. 1 also comprises the respective body diodes and the drain-to-source parasitic capacitances Cs1, Cs2 of the aforesaid transistors.

The general criteria of operation of a power-supply/converter of the type described are to be deemed widely known in the art, which renders superfluous providing a more detailed description herein, this also taking into account the fact that the examples presented herein mainly regard the modes of implementation of the transformer 10.

As already mentioned, the transformer in question comprises a primary winding Lpri, which may be coupled between the node HB and the reference level GND. In the diagram of FIG. 1, the reference Lm denotes, according to current modalities, the magnetization inductance of the primary winding Lpri, while the reference Crp denotes a resonance capacitance connected in series to the primary winding Lpri.

The transformer 10 then has two secondary windings Ls1, Ls2 coupled to the primary winding Lpri via a core C.

The secondary windings Ls1 and Ls2 may be seen as being connected in series to one another (with a resonance capacitance of the secondary side Crs set in series) across the output terminals (i.e., across the capacitor Cₒ).

The reference D denotes a rectifier diode coupled to the cathode at an intermediate node B between the secondary windings Ls1 and Ls2 and to the anode with the side of the output capacitor Cₒ opposite to the side of the capacitor C. connected to the secondary winding Ls1.

The reference Laux denotes an auxiliary winding, which is coupled to the winding Ls1 and us to supply an output signal AUX that may be used, for example, for purposes of control of the power-supply/converter.

As already mentioned, the general configuration of connection represented in FIG. 1 is to be deemed as a whole known and in itself non-limiting for the specific purposes of the present description.

The transformer 10 represented here by way of example has a (single) coil former designated by 100, which is to provide chambers for enabling winding of respective windings (coils) Lpri, Ls1, Ls2 (and Laux) of the transformer 10.

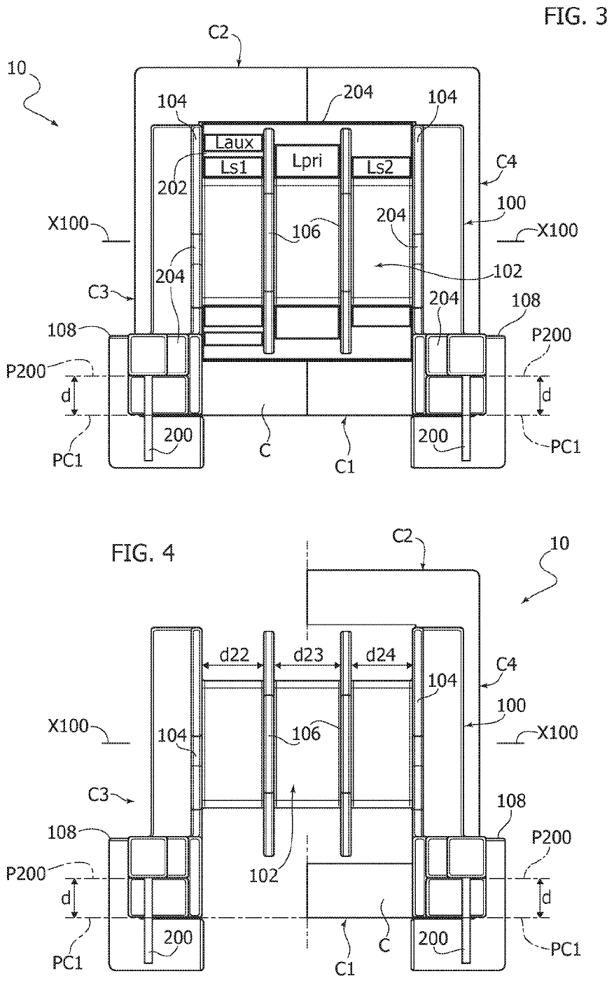

In some of the figures of the annexed sheets of drawings (for example, in FIG. 3) the representation of the windings Lpri, Ls1, Ls2, and Laux is deliberately schematic for greater clarity of illustration.

For the same reason, in other figures (for example, FIG. 4) the coil former 100 is illustrated without reproducing the windings, Lpri, Ls1, Ls2, and Laux wound thereon.

Once again, the possibility of connecting the ends of the windings in question (ends denoted by W) to electrical-connection pins 200 is represented by dashed lines just in FIG. 6.

According to a solution in itself known, for example from EP 1 796 112 B1, it is envisaged that the primary winding Lpri be wound on the central part of the coil former 100 with the secondary windings Ls1 and Ls2 wound on opposite sides with respect to the primary winding Lpri.

The windings Lpri, Ls1, Ls2 may be viewed as being wound around the central body 102 of the coil former about one and the same longitudinal axis X100 of the coil former 100, with the winding Laux wound around the winding Ls1.

The windings wound on the coil former 100 are consequently wound around a winding axis, which extends in a longitudinal direction X100 of the coil former 100.

As in the case of the document just cited, even though a transformer comprising three windings (hence three winding chambers) is described herein by way of example, the solutions described herein may extend to and also comprise a different number of windings.

As described herein, the coil former 100 comprises a tubular body 102 (for example, having a rectangular cross section substantially aligned with the axis X100 of the body 102) made of an electrically insulating material and having a thickness such as to meet the insulation safety standards.

Printed materials such as polyamide, polycarbonate or else polybutylene terephthalate with a resistivity, for instance, in the region of 3·10⁹ Ω·cm, exemplify such a material.

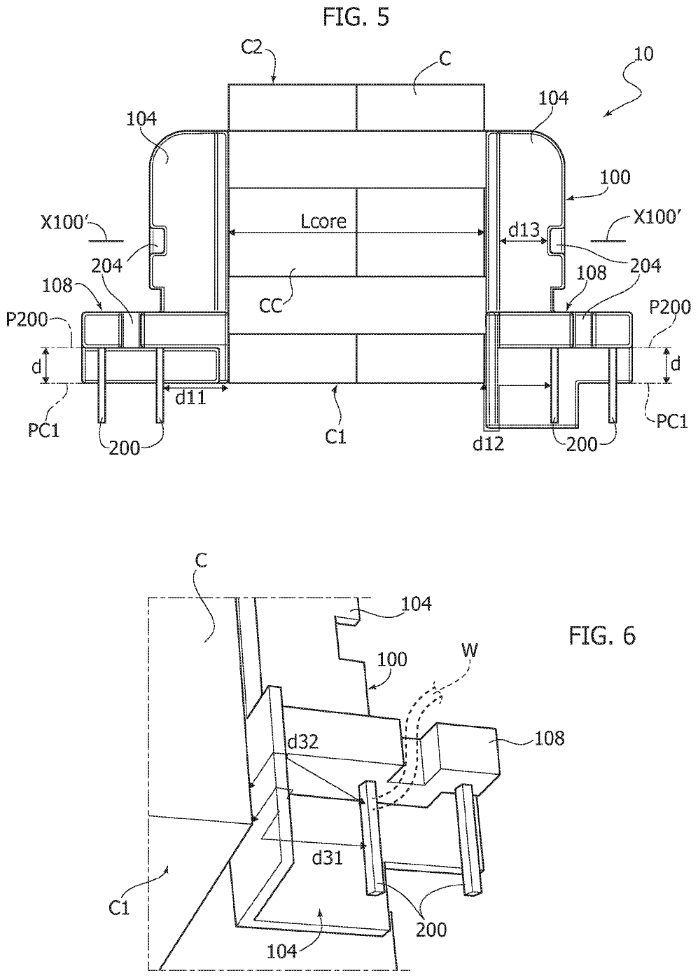

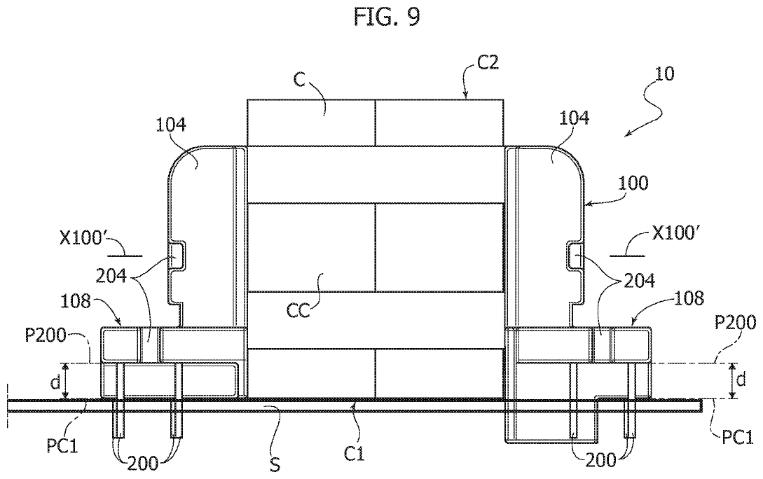

In the finished transformer 10, the windings Lpri, Ls1, Ls2 formed on the coil former 100 are in effect “fitted”, alongside one another, on the main central branch CC (visible in FIGS. 5 and 9) of a ferromagnetic core C (for example, a ferrite core) having an overall annular shape set around the windings Lpri, Ls1, Ls2 (and Laux): see, for example, in this regard FIGS. 3 and 4.

The chambers in which the windings Lpri, Ls1, Ls2 are located are axially delimited by transverse insulating flanges 104, 106, which may form an integral part of the coil former 100 (made of a single piece with the central body 102).

As illustrated, the flanges 104, 106 extend in a transverse direction (indicated by an axis X100′ in some of the figures, such as in FIG. 5) with respect to the aforesaid longitudinal direction X100.

As illustrated, the transverse flanges in question (having an overall annular shape and an outer contour, for example, of an at least approximately rectangular shape) comprise:
two outer insulating flanges 104, which define the distal sides of the winding spaces or chambers where the two secondary windings Ls2 are wound; and
two inner insulating flanges 106, which on one side define the proximal sides of the winding spaces or chambers in which the two secondary windings Ls1, Ls2 are wound and on the other side define between them the winding space where the primary winding Lpri is wound.

The two inner insulating flanges 106 separate (e. g., creating the necessary paths through the structure, the creepage distances, and the necessary thickness) the primary winding Lpri from the secondary windings Ls1 and Ls2.

As illustrated in the figures, the coil former 100 also comprises projecting lateral formations (at times referred to as “rails”) 108, arranged in which are the contacts or pins 200 to which the ends of the various windings of the transformer 10 are connected.

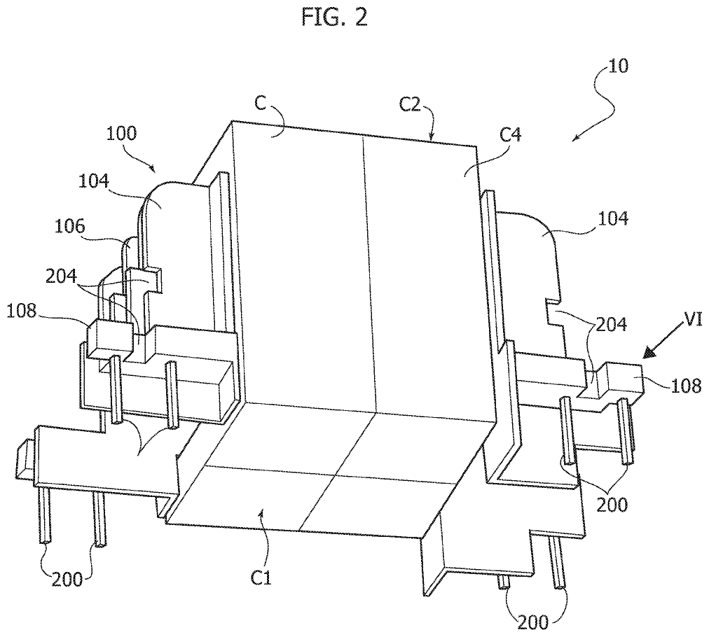

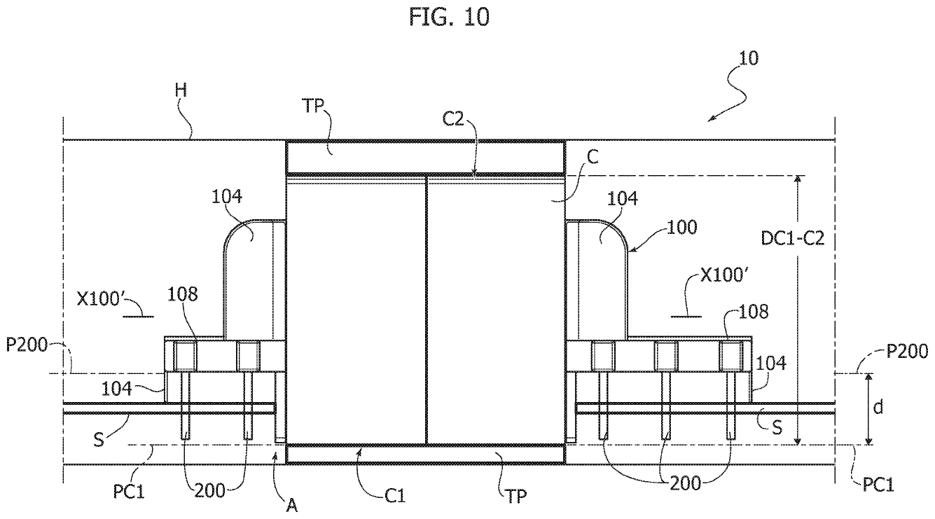

As may be appreciated, for example, in the perspective views of FIG. 2 and of FIG. 6, the supporting formations 108 basically extend from the main walls of the tubular core of the coil former 100 (where the outer flanges 104 are located). The inner flanges 106 extend, instead, only marginally underneath the aforesaid main walls that are to face the substrate S—for example, a PCB, visible in FIGS. 9 and 10—on which the transformer 10 can be mounted according to the criteria described more fully in what follows.

In brief, the transformer 10 comprises a coil former 100, wound on which are a plurality of windings Lpri, Ls1, Ls2, Laux.

As has been seen, the coil former 100 has a central body 102 elongated in a longitudinal direction (axis X100) and a plurality of transverse flanges 104, 106 defining mutually insulated chambers that house the windings Lpri, Ls1, Ls2, Laux.

The winding chambers are arranged alongside one another in a longitudinal direction (axis X100) of the coil former between two outermost transverse flanges 104. These two outermost flanges 104 are consequently located so as to have the windings Lpri, Ls1, Ls2, Laux arranged between them, with the core C that surrounds the windings Lpri, Ls1, Ls2, Laux wound on the coil former 100.

From the figures it may likewise be noted that the transformer core C has a first outer or end surface C1 and a second outer or end surface C2 that lie on opposite sides (below and above) with respect to the windings Lpri, Ls1, Ls2, Laux.

The first outer surface C1 of the transformer core C is a surface lying in a plane PC1 that extends in the longitudinal direction X100 and in the transverse direction X100′ (or, more formally, in a plane belonging to the family of the planes that extend in the longitudinal direction X100 and in the transverse direction X100′ and are identified by these directions).

In the example illustrated herein, this also applies to the surface C2.

In particular, with reference to the point of view of the annexed drawings, the outer surface C1 is set “beneath” the windings Lpri, Ls1, Ls2, Laux, whereas the outer surface C2 is set “above” the windings Lpri, Ls1, Ls2, Laux.

In the example presented herein, the core C has an overall rectangular shape with the outer surfaces C1 and C2 defining a first pair of opposite faces of the rectangular profile that are connected by a further two outer surfaces C3 and C4, which define a second pair of opposite faces of the rectangular profile.

It will be appreciated that the two further outer surfaces C3 and C4 lie in planes orthogonal with respect to the longitudinal direction X100 of the coil former 100.

The coil former 100 comprises the lateral extensions or projections 108 that project from the coil former 100 prevalently in a transverse direction (axis X100′ represented in FIGS. 5 and 8 to 10) with respect to the longitudinal direction identified by the axis X100, around which the windings Lpri, Ls1, Ls2, and Laux are wound.

The lateral extensions 108 carry the contacts or pins 200 projecting away from the coil former 100 (in a direction substantially orthogonal to the family of planes identified by the longitudinal axis X100 and the transverse axis X100′ of the coil former 100/transformer 10) in the proximity of the surface C1 of the core C.

In brief, the transformer 10 illustrated herein comprises a coil former 100 with a plurality of windings Lpri, Ls1, Ls2, Laux wound thereon.

The coil former illustrated herein comprises a plurality of transverse flanges 104, 106 defining mutually insulated winding chambers for the windings Lpri, Ls1, Ls2, Laux. These mutually insulated winding chambers are arranged alongside one another in a longitudinal direction (axis X100) of the coil former between two outermost transverse flanges 104, with the outermost transverse flanges 104 that are located so as to have the plurality of windings Lpri, Ls1, Ls2, Laux arranged between them.

The side-by-side (and not concentric) location of the windings facilitates the automated winding operations.

The side-by-side location of the windings likewise facilitates an arrangement of the transformer “lengthwise” and not flat (see, for example, FIGS. 9 and 10), thus countering the undesired excessive increase in overall dimensions (in particular, the vertical dimension) of the transformer as the number of windings (and the number of turns of the windings) increases.

The transformer core designated by C surrounds the windings Lpri, Ls1, Ls2, Laux wound on the coil former and has a first outer surface C1 and a second outer surface C2 that extend on opposite sides with respect to the windings Lpri, Ls1, Ls2, Laux.

The coil former 100 likewise comprises the lateral extensions 108 located at the opposite ends of the first outer surface C1 of the transformer core C.

These lateral extensions 108 carry the electrically conductive pins (contacts) 200 that project from the lateral extensions 108 of the coil former 100.

The electrically conductive pins 200 have:
proximal ends coupled to respective windings from among the windings Lpri, Ls1, Ls2, Laux; and
distal ends projecting from the lateral extensions 108 of the coil former 100.

At least the first outer surface C1 of the transformer core C is a surface lying in a plane denoted by PC1, and the electrically conductive pins 200 project from the lateral extensions 108 of the coil former 100 starting from a plane P200 of the lateral extensions 108 that is set in with respect to the plane PC1 of the first outer surface C1 of the transformer core C.

The examples presented here deal with various themes linked to the use of the solution described in the filed document EP 1 796 112 B1, to which reference has been made a number of times previously.

For instance, it may be desirable to be able to increase the number of turns comprised in each of the secondary windings Ls1 and Ls2 so as to arrive, for example, at forty turns for each winding.

It may likewise be desirable to be able to add the auxiliary winding Laux, taking into account the fact that, even though it is likely to comprise a small number of turns (for example, two or three turns), the auxiliary winding Laux is provided with respective pins 200 from which it is possible to obtain the signal AUX. The addition of these pins may reduce the insulation distance with respect to the insulation distance between pins already present in the transformer. Moreover, there should be taken into account the need to have an adequate common-mode insulation in the presence of possible surges and/or the choice to do without a protective cover as envisaged in EP 1 796 112 B1 in so far as this cover has an adverse effect on the overall dimensions of the transformer.

In this regard, it has been noted that the fact of retaining the cover in question would entail drawbacks of various nature:
the addition of pins for the auxiliary winding Laux could give rise to problems regarding the insulation that is necessary for safety and surge strength; this would preclude, for example, one of the advantages linked to the fact of dividing the secondary winding into two portions Ls1 and Ls2 located on opposite sides with respect to the primary winding Lpri;
the increase in losses or leakages may also increase the phenomena of ringing across the diode D since the transformer would have a smaller equivalent magnetic area (given the same overall dimensions) and hence would require windings with a greater number of turns; and
again, there would be an increase in the losses in the copper since it would be necessary to reduce the section of the wire because the cover would take up space.

Added to the above is the fact that the distances between the pins 200 may reach critical values.

In comparison with the solutions according to the prior art, examples of embodiment presented herein make it possible to maintain substantially unvaried the footprint of the transformer 10 (i.e., the area occupied on the substrate S—for example a PCB—of FIGS. 9 and 10) with the possibility of containing the undesirable phenomena of ringing and of providing a good distance of insulation between the pins even in the presence of rather high operating powers (for example, 200 W with an output Vₒ of approximately 320 V).

As illustrated, for example, in FIG. 3:
the primary winding Lpri is wound in the central chamber of the coil former 100, between the inner flanges 106, with the secondary windings Ls1 and Ls2 set alongside; and
the auxiliary winding Laux is wound around the portion Ls1 of the secondary winding (i.e., in the respective chamber of the coil former 100), separated from the portion Ls1 of the secondary winding by an electrically insulating layer (for example, a layer of tape) 202, which is present more than anything for mechanical reasons; and
a similar laminar insulating winding (for example, a tape) 204 wound on the edge of the flanges 104, 106 provides a separation of the windings Lpri, Ls1, Ls2, Laux from the core C.

The transformer 10 exemplified herein hence comprises a laminar insulation designated by 204, which is wound around the windings Lpri, Ls1, Ls2, Laux and extends (as viewed in the direction of the axis X100) from one of the two outermost transverse flanges 104 to the other.

The laminar insulation 204 separates (insulating also electrically) the windings Lpri, Ls1, Ls2, Laux from the core C of the transformer.

As has been seen, the windings Lpri, Ls1, Ls2, Laux also comprise an auxiliary winding Laux, which is wound on the coil former 100 by being wound around another winding Ls1 comprised between the windings Lpri, Ls1, Ls2, Laux and shares with the aforesaid other winding Ls1 a common winding chamber between two flanges 104 and 106.

The aforesaid other winding (Ls1) can be advantageously set on the secondary side Ls1, Ls2 of the transformer 10,

A laminar separation 202 is provided, which is wound around the aforesaid other winding (Ls1) and separates the aforesaid other winding from the auxiliary winding Laux wound around it.

The primary winding Lpri is obtained with enamelled wire, whereas the secondary windings Ls1, Ls2 (as well as the auxiliary winding Laux) are obtained with wire having triple insulation. This may, for example, be the wire with triple insulation commercially available under the brand name TEX-E manufactured by the company FURUKAWA Electric of Tokiwabashi Tower, 2-6-4, Ohtemachi, Chiyoda-ku, Tokyo (Japan).

As mentioned, the insulation (tape) 202 between the secondary winding Ls1 and the auxiliary winding Laux prevalently performs a mechanical function, whereas the insulation 204 operates in maintaining the core C insulated from the windings Lpri, Ls1, Ls2, and Laux.

In the presence of stringent needs of insulation, it is possible to use a wire having triple insulation (also) for the primary winding Lpri.

The solution presented herein is suited to providing the core C by resorting to four half-cores—e.g., made of ferrite—of dimensions (in millimetres) 25×13×11, which makes it possible to provide a particularly compact structure. Of course, these values may be modified, i.e., either increased or reduced.

By resorting to a solution as described herein it is possible, for example, to have a primary winding Lpri with thirty turns and windings Ls1, Ls2 with twenty-three turns and a value of inductance for the primary winding Lpri of 640 μH and with a leakage between the primary winding Lpri and Ls1 and between Lpri and Ls2 in the region of 40-80 μH.

In a solution as described herein, the lateral extensions 108 of the coil former 100 project from the coil former in a direction transverse to the longitudinal direction (axis X100) of the coil former 100 itself.

A solution as illustrated herein makes it possible to obtain a double insulation between the primary side and the secondary side without referencing the core C either to the primary side or to the secondary side. In this way, it is possible to exploit the surrounding space with a high level of insulation between the primary side and the secondary side. The representation of FIG. 4 (where the windings are not visible for clarity of illustration) highlights the fact that the dimensions of the various chambers (and in particular the distance d23 between the two inner flanges 106 and the distances d22 and d24 between each of the inner flanges 106 and the outer flange 104 associated thereto) may be varied according to the number of turns comprised in each winding (it will be noted that the secondary windings Ls1 and Ls2 do not necessarily have to have the same number of turns).

The contacts or pins 200 have proximal ends coupled to the windings Lpri, Ls1, Ls2, Laux and distal ends projecting from the lateral extensions 108 in a direction substantially orthogonal to the family of planes identified by the longitudinal axis X100 and the transverse axis X100′ of the coil former 100/transformer 10.

In the examples considered herein, the first terminal or outer surface C1 of the transformer core C is identifiable as an (at least substantially) plane surface lying in a plane PC1.

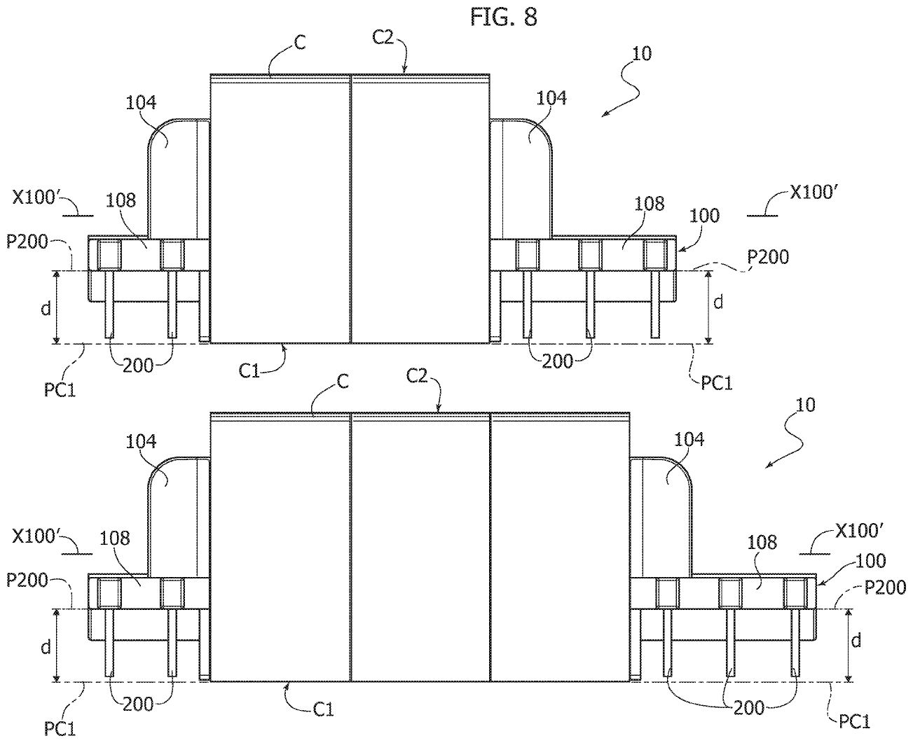

As represented in some of the figures, such as FIGS. 3 to 5 or again FIGS. 8 to 10, the electrically conductive pins 200 project from the lateral extensions 108 of the coil former 100 starting from a (proximal) plane P200 that is set in by a distance d from the plane PC1 in which the first outer surface C1 of the transformer core C lies.

In other words, the electrically conductive pins 200 project from the lateral extensions 108 of the coil former 100 in a direction orthogonal both to the longitudinal direction X100 and to the transverse direction X100′ starting from a plane P200 of the lateral extensions 108 that is set in (by a distance d) from the plane PC1 of the first outer surface C1 of the transformer core C.

The presence (and the length) of the above distance d, from which the plane P200 is set in by a (stand-off) distance d from the plane PC1 assumes importance for various aspects treated in what follows.

FIG. 6 highlights how, in the solution illustrated herein, it is possible to work on the distance between the pins 200 that are located closer to the core C, to obtain a desired level of insulation both between pins 200 and core C—creepage (distance d31 shown in FIG. 6) or clearance (distance d32 shown in FIG. 6).

This fact is further highlighted, for example, by the distance d11 shown in FIG. 5, it likewise being possible to note the possibility of providing a labyrinthine configuration (see the distances d12 shown in FIGS. 5 and d31 shown in FIG. 6).

In this way (with reference for simplicity just to FIG. 6), it is possible to have a situation in which, in the presence of a geometrical distance or clearance represented by d32, it is possible to obtain a creepage equal to d31 in so far as the wall of the coil former 100 (for example, one of the bottom ends of one of the flanges 104) is inserted into the substrate (for example, a PCB) as represented in FIG. 10, discussed in what follows.

FIG. 5 highlights how the dimensions of the core C may be adjusted (for example, the width Lcore in the transverse direction: axis X100′) so as to receive (half) cores C of a standardized type, without any need to resort to custom-built cores.

For instance, it is possible to use, as has already been said, four half-cores with dimensions (in millimetres) of 25×13×11. This flexibility is represented in an explicit way in FIG. 8.

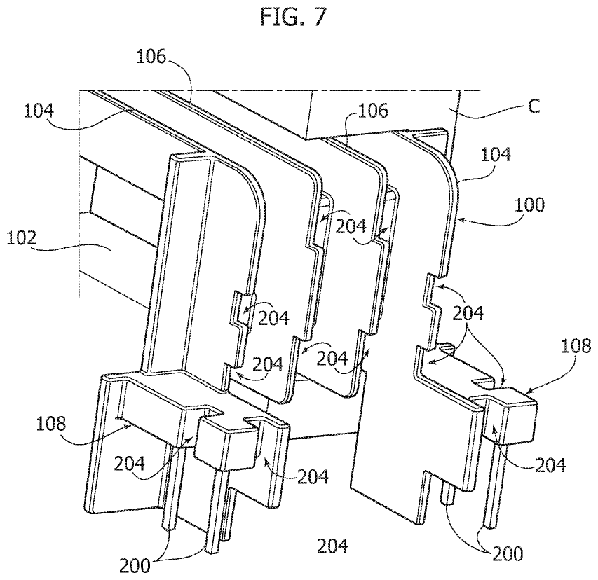

FIGS. 6 and 7 highlight the possibility of providing, both in the flanges 104, 106 and in the formations 108, notches 204 for inserting and guiding the ends W of the windings Lpri, Ls1, Ls2, and Laux so as to keep them firmly in position fixed with respect to the pins 200.

FIGS. 9 and 10 highlight various advantageous modes of mounting the transformer 10 on a substrate S such as a PCB, exploiting the fact that the first outer surface C1 and the second outer surface C2 of the transformer core C are exposed surfaces (without covering caps or domes) so as to facilitate dissipation of heat from the transformer.

This may happen in the context of a mounting assembly comprising a mounting substrate S (for example, a PCB) having the transformer 10 mounted thereon.

For instance, FIG. 9 exemplifies the possibility of mounting the transformer 10 with the core C (or rather, the bottom planar surface C1 of the core C) that rests on the substrate S. In this way, the transformer 10 is mounted on the mounting substrate S with the first outer surface C1 of the core C of the transformer (surface lying in the plane PC1) resting on the mounting substrate S. This mounting solution facilitates passage (dissipation) of the heat produced by the transformer during operation starting from the core C towards the substrate S (and possibly also starting from the top outer surface C2 of the core C, which-whether plane or not—is left uncovered, without protective housings).

FIG. 9 exemplifies the fact that, since the plane P200 is at the distance d from the plane PC1, the formations 108 are located in any case at a certain (stand-off) distance from the substrate S. As may be appreciated, for example, in the view of FIG. 6 this leaves (above the support S) space for connecting the wires W of the windings Lpri, Ls1, Ls2, Laux (which are to pass into the notches 204) to the respective pins 200.

FIG. 9 highlights the fact that the “vertical” encumbrance of the transformer above the substrate S in this case ends up coinciding with the distance between the surfaces C1 and C2 (denoted by DC1-C2 in FIG. 10), without this resulting in an increase in the horizontal footprint, i.e., in the space of the substrate S occupied by the transformer 10.

FIG. 10 highlights the possibility of mounting the transformer 10 “recessed” in an opening A purposely provided in the substrate S itself, with the bottom planar surface C1 and the top surface C2 of the core C located below and above the substrate S.

In this way, the transformer 10 is mounted on the mounting substrate S in an opening (A) in the substrate S itself, with the first outer surface C1 and the second outer surface C2 of the core C that lie on opposite sides of the mounting substrate S.

In this way, the “vertical” encumbrance of the transformer above the substrate S coincides exactly with the distance DC1-C2 between the surfaces C1 and C2, with the possibility of reducing further the “vertical” encumbrance of the transformer 10 above the substrate S, with the transformer 10 that projects also beneath the substrate, for example reducing the amount by which the transformer 10 projects above the substrate S “masking” the portion of the transformer 10 situated underneath the bracket formations 108 (plane P200) within and underneath the substrate S.

As may be appreciated in FIG. 10, in addition to bringing about a reduction in the encumbrance in height of the transformer 10 as this is mounted on the substrate S, this solution also makes it possible to mount interfaces or bearings made of a material with high thermal conductivity, denoted by TP, either beneath or above the core C, exploiting the fact that both of the surfaces C1 and C2 are free.

It is thus possible to dissipate the heat generated by the transformer 10 during operation towards the walls of a housing H in which the transformer may be mounted (possibly together with the other parts of the power-supply or converter that incorporates it—see the general diagram of FIG. 1).

A similar solution is suited to being implemented, at least in relation to the top surface C2, also in a solution like the one exemplified in FIG. 9.

These are hence solutions in which the assembly comprises a housing H with at least one between the first outer surface C1 and the second outer surface C2 of the core C of the transformer thermally coupled (by simple contact or possibly via interfaces or bearings made of a material with high thermal conductivity TP) to the housing H.

Of course, without prejudice to the underlying principles, the details and embodiments may vary with respect to what has been illustrated herein purely by way of example, without departing from the scope of the present disclosure, as specified in the annexed claims.

### LIST OF REFERENCE SIGNS

Input node IN
Input signal Vin
Controller MC
Node HB
Switches S1, S2
Parasitic capacitances of switches Cs1, Cs2
Capacitances of resonant circuit Crp, Crs
Diode D
Output capacitor Cₒ
Output voltage Vₒ
Output current Iₒ
Load L
Auxiliary output AUX
Transformer 10
Coil former 100
Windings Lpri, Ls1, Ls2,
Laux
Transverse flanges 104, 106
Longitudinal axis of coil former X100
Transverse axis of coil former X100′
Transformer core C
First outer surface C1
Second outer surface C2
Third outer surface C3
Fourth outer surface C4
Lateral extensions 108
Pins 200
Notches for passage of wires 204
Winding ends W
Plane of first outer surface PC1
Plane of lateral extensions P200
Distance between PC1 and P200 d
Laminar separation 202
Laminar insulation 204
Mounting substrate S
Thermal coupling TP
Housing H

What is claimed is:

1. A transformer, comprising:
a coil former with a plurality of windings wound on the coil former around a winding axis extending in a longitudinal direction of the coil former wherein the coil former includes a plurality of transverse flanges extending in a direction transverse to the longitudinal direction, the transverse flanges defining mutually insulated winding chambers for the windings in said plurality of windings, the mutually insulated winding chambers being arranged side by side in a longitudinal direction of the coil former between two outermost transverse flanges in the plurality of transverse flanges, wherein the two outermost transverse flanges have the plurality of windings arranged therebetween, and
a transformer core surrounding the plurality of windings wound on the coil former, the transformer core having a first outer surface and a second outer surface extending at opposite sides of the plurality of windings wound on the coil former, wherein the coil former comprises lateral extensions at opposed ends of the first outer surface of the transformer core, the lateral extensions carrying electrically conductive pins projecting away from the lateral extensions of the coil former, the electrically conductive pins having proximal ends coupled to windings in the plurality of windings and distal ends projecting away from the lateral extensions of the coil former,
wherein:
the first outer surface of the transformer core is a surface lying in a plane extending in said longitudinal direction and said transverse direction, and
the electrically conductive pins project away from the lateral extensions of the coil former in a direction orthogonal to said longitudinal direction and said transverse direction from a plane of the lateral extensions that is set in with respect to the plane of the first outer surface of the transformer core.

2. The transformer of claim 1, further comprising a laminar insulation wound around the plurality of windings from the one to the other of the two outermost transverse flanges, the laminar insulation separating the plurality of windings from the transformer core.

3. The transformer of claim 1, wherein the plurality of windings comprises an auxiliary winding wound on the coil former by being wound around another winding in the plurality of windings and sharing a common winding chamber with said another winding.

4. The transformer of claim 3, wherein said another winding in the plurality of windings is arranged at the secondary side of the transformer.

5. The transformer of claim 3, further comprising a laminar separation wound around said another winding and providing separation between said another winding and the auxiliary winding wound therearound.

6. The transformer of claim 1, wherein the lateral extensions of the coil former project from the coil former in a direction transverse to said longitudinal direction of the coil former.

7. The transformer of claim 1, wherein the first outer surface and the second outer surface of the transformer core are exposed surfaces configured to facilitate dissipation of heat from the transformer.

8. An assembly, comprising:
a transformer comprising:
a coil former with a plurality of windings wound on the coil former around a winding axis extending in a longitudinal direction of the coil former wherein the coil former includes a plurality of transverse flanges extending in a direction transverse to the longitudinal direction, the transverse flanges defining mutually insulated winding chambers for the windings in said plurality of windings, the mutually insulated winding chambers being arranged side by side in a longitudinal direction of the coil former between two outermost transverse flanges in the plurality of transverse flanges, wherein the two outermost transverse flanges have the plurality of windings arranged therebetween, and
a transformer core surrounding the plurality of windings wound on the coil former, the transformer core having a first outer surface and a second outer surface extending at opposite sides of the plurality of windings wound on the coil former, wherein the coil former comprises lateral extensions at opposed ends of the first outer surface of the transformer core, the lateral extensions carrying electrically conductive pins projecting away from the lateral extensions of the coil former, the electrically conductive pins having proximal ends coupled to windings in the plurality of windings and distal ends projecting away from the lateral extensions of the coil former, wherein:
the first outer surface of the transformer core is a surface lying in a plane extending in said longitudinal direction and said transverse direction, and
the electrically conductive pins project away from the lateral extensions of the coil former in a direction orthogonal to said longitudinal direction and said transverse direction from a plane of the lateral extensions that is set in with respect to the plane of the first outer surface of the transformer core; and
a mounting substrate having the transformer mounted thereon.

9. The assembly of claim 8, wherein the transformer is mounted on the mounting substrate with the first outer surface of the transformer core lying against the mounting substrate.

10. The assembly of claim 8, wherein the transformer is mounted on the mounting substrate in an opening in the mounting substrate, wherein the first outer surface and the second outer surface of the transformer core lie on opposite sides of the mounting substrate.

11. The assembly of claim 8, wherein the assembly further comprises a housing, with wherein at least one of the first outer surface and the second outer surface of the transformer core thermally coupled with the housing
